(19) United States
(12) Patent Application Publication
(10) Pub. No.: US 2015/0356638 A1
(43) Pub. Date: Dec. 10, 2015

(54) METHOD OF FACILITATING DONATIONS TO CHARITIES

(71) Applicant: SAFE2GIVE, LLC, Peoria, AZ (US)

(72) Inventors: Mack E. Bradley, Peoria, AZ (US); Chad L. Chandler, Centreville, MS (US)

(21) Appl. No.: 14/296,683

(22) Filed: Jun. 5, 2014

(51) Int. Cl. G06Q 30/02; G06Q 30/06

(52) U.S. Cl. CPC G06Q 30/0279; G06Q 30/0633; G06Q 30/0623

(57) ABSTRACT

A method of facilitating charitable donations includes providing an organizations database comprising a listing of charitable organizations, and an items database comprising a listing of tangible items, such as food, water, clothing, building supplies, medical supplies, and/or educational materials, available for purchase by potential donors for the charitable organizations. At least one of the tangible items is designated for donating to at least one of the charitable organizations, and potential donors can search the items database and select desired tangible items to purchase for one or more of the charitable organizations. The tangible items selected from the items database are purchased by the user and donated to the designated charitable organization.

### TECHNICAL FIELD AND BACKGROUND OF THE INVENTION

The present invention relates to a method for facilitating charitable donations. One embodiment of the invention comprises a method in which users of an Internet website can select and purchase particular items, such as food or clothing, for a particular charity selected by the user. Users have assurance that the money they spend reaches the intended charity, and is used for the purpose intended by the user.

Charitable organizations rely heavily on financial contributions from donors, and telephone solicitations for donations have become common. Often such telephone solicitations are not done by the charity itself, but rather an independent third party firm that specializes in telephone solicitations and retains a percentage of all donations collected. It has become known that many such firms retain more than fifty percent of the donations collected. As such, the general public has become increasingly weary of donating any money in response to such telephone solicitations. In addition, there have been instances, in which charitable organizations have engaged in fraud and misappropriation of funds. There have also been scandals, in which it has been revealed that employees of some charities received exorbitant salaries and benefits. Due to media coverage, the public is very aware of these cases, and therefore many are reluctant to donate to a charitable organization for fear that the donation may not be used in the manner intended. This breakdown in the public trust is a challenge that can limit donations and prevent donations all together.

### SUMMARY OF THE INVENTION

Therefore, one object of the present invention is to provide a method to facilitate donations to charitable organizations, in which the donor is assured that the donation is received directly by the intended organization. Another object of the present invention is to provide a method of facilitating charitable donations, in which donors are assured of the manner in which their donation will be used by the intended recipient.

These and other objects of the present invention can be achieved in the preferred embodiments of the invention described below. One embodiment of the invention comprises a method of facilitating charitable donations comprising the steps of providing an organizations database comprising a listing of charitable organizations, and an items database comprising a listing of tangible items available for purchase by potential donors for the charitable organizations. At least one of the tangible items is designated for donating to at least one of the charitable organizations, and potential donors can search the items database and select desired tangible items therefrom to purchase for one or more of the charitable organizations. The tangible items selected from the items database are purchased by the user and donated to the designated charitable organization.

According to another embodiment of the invention, the purchased tangible items are delivered to the designated charitable organizations.

According to another embodiment of the invention, the tangible items can be food, water, clothing, building supplies, medical supplies, and/or educational materials.

According to another embodiment of the invention, a forum, such as an Internet website, is provided in which potential donors can search the organizations database and the items database.

According to another embodiment of the invention, an administrator maintains the website, and oversees activity on the website.

According to another embodiment of the invention, the tangible items listed in the items database are classified according to the cost of each of the items. As such, potential donors can search for items based on cost.

According to another embodiment of the invention, the charitable organizations listed in the organizations databases are classified into a plurality of sub-databases to facilitate searching of the charitable organizations.

According to another embodiment of the invention, charitable organizations having a particular common mission are classified in a common sub-database whereby potential donors can search for organizations having the particular mission.

According to another embodiment of the invention, the charitable organizations are classified according to their geographical location so that potential donors can search for organizations in a particular geographical area.

According to another embodiment of the invention, a system for facilitating charitable donations comprises a database that includes charitable organizations and tangible items available for purchase for the charitable organizations. Each charitable organization is designated as a recipient of at least one of the tangible items. The database is functionally connected to an Internet website, such that a user of the website can search the database and select at least one of the tangible items in the database to purchase for the charitable organization designated as recipient of the tangible item.

According to another embodiment of the invention, the website includes a purchasing portal for executing the purchase of tangible items.

According to another embodiment of the invention, the tangible items are food, water, clothing, building supplies, medical supplies, and/or educational materials.

According to another embodiment of the invention, the tangible items are classified in a plurality of sub-categories functionally connected to the website to facilitate searching of the tangible items by the user of the website.

According to another embodiment of the invention, each of the tangible items is assigned an expiry date, and each of the tangible items having an expiry date within a specified time period are classified by expiry date, whereby the user of the website can search for items by expiry date.

According to another embodiment of the invention, the tangible items are classified according to the cost of each of the items, such that the user of the website can search for items based on cost.

According to another embodiment of the invention, the charitable organizations are classified into a plurality of sub-categories functionally connected to the website to facilitate searching of the charitable organizations by the user of the website.

According to another embodiment of the invention, charitable organizations having a particular common mission are classified in a common sub-category so that potential donors can search for organizations having the particular mission.

According to another embodiment of the invention, the charitable organizations are classified according to their geographical location so that potential donors can search for organizations in a particular geographical area.

According to another embodiment of the invention, the website includes a profile page for each of the charitable organizations. The profile page provides information about the charitable organization.

### BRIEF DESCRIPTION OF THE DRAWINGS

FIGS. 1 and 2 are schematic views illustrating of a method of facilitating charitable donations according to a preferred embodiment of the invention.

### DESCRIPTION OF THE PREFERRED EMBODIMENTS OF THE INVENTION AND BEST MODE

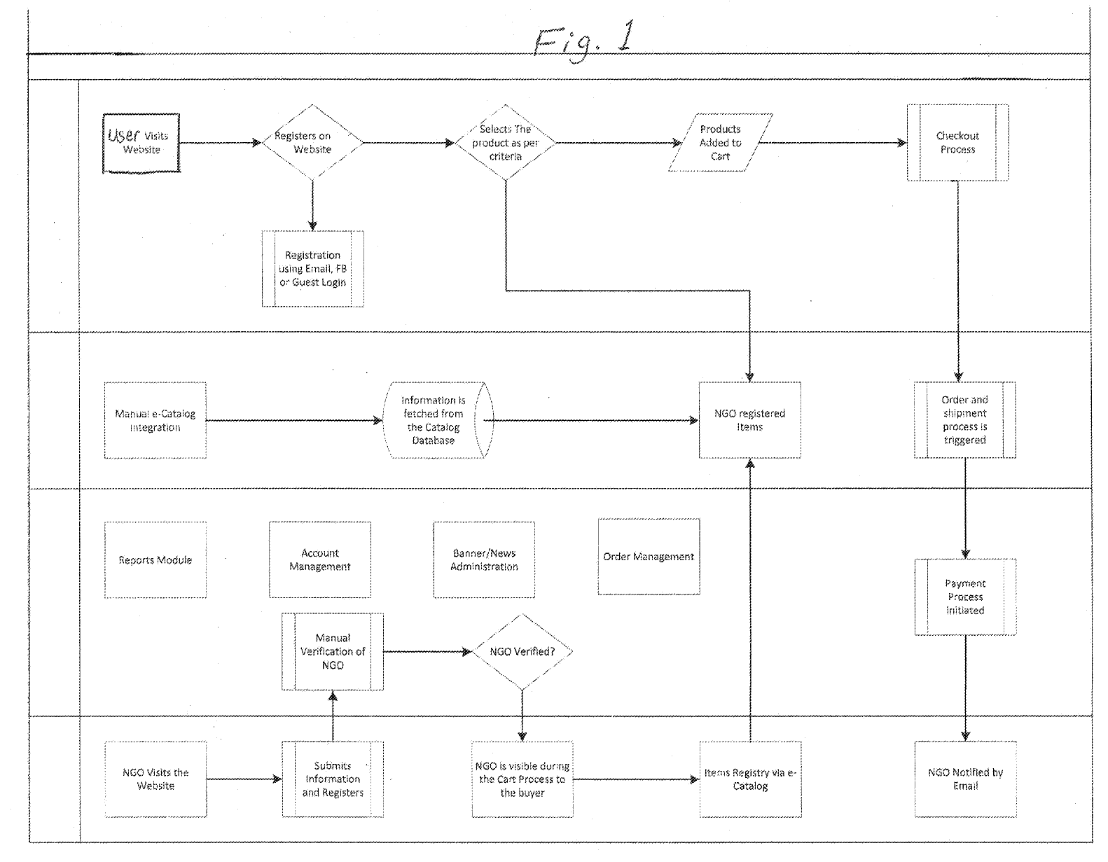

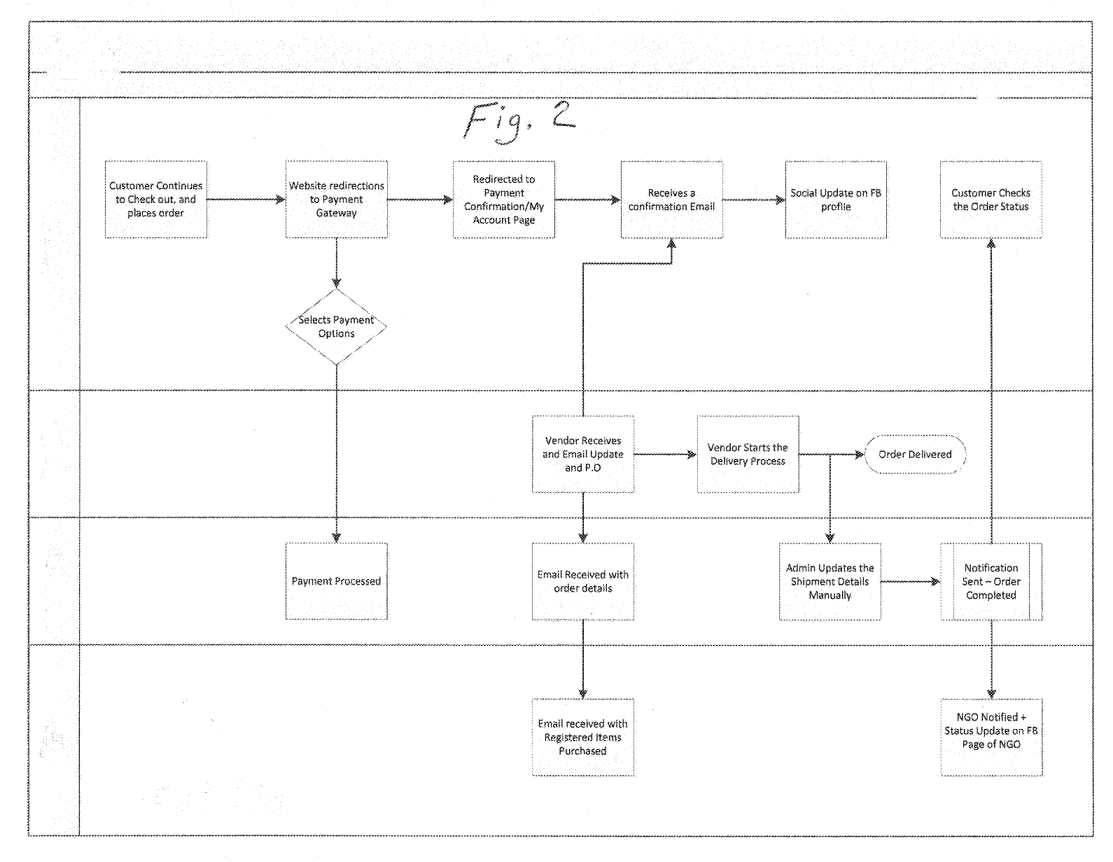

A method of facilitating donations to charitable organizations according to a preferred embodiment of the invention is illustrated in FIGS. 1 and 2. As used throughout this application “charitable organization” refers generally to non-governmental organizations and/or not for profit entities having a charitable, philanthropic and/or social welfare purpose.

An Internet website is set up and maintained by an administrator. The administrator can be an individual or group of people. A user (potential donor) who is interested in making a donation to a charitable organization visits the website. The customer is asked to register on the website. The customer is given the option of registering using an e-mail address, Facebook® account, or guest log-in.

When a user comes onto the website, he lands on a home page. On the homepage, the user has the option to search for items by: (a) organization, (b) cause, (c) price, (d) location of the organization, and/or (e) urgency of need. Additional categories and home page listings can be used.

A database of charitable organizations that have elected to participate in the process is maintained on the website. Each participating charitable organization has a profile page on which it can provide a list of items that they need, and would like donors to purchase and donate to the particular charitable organization. The items can be tangible goods, such as food, water, clothing, building supplies, medical supplies, educational materials and other items commonly used by charitable organizations in carrying out their respective missions. The profile page can also include information about the charitable organization, such as its mission, what it does to try to achieve its mission, and links to social connectors to follow the organization. The profile page can also provide areas to upload YOUTUBE videos and photos to showcase what the organization does and have more people be a part of the cause.

The participating charitable organizations are classified into different classification groups according to their particular cause or mission. For example, charitable organizations that set up to aid victims of domestic abuse are classified together, while organizations that address homelessness are classified together. Multiple organizations may have multiple charitable/social causes, and can be classified accordingly. A user has the capability to select and search by a particular cause in which he is interested, and is provided a listing of all participating organizations from which he can select to make a donation.

Another option the user has is to search by price. The items which each participating charitable organization has listed as options for users to donate are organized in a database according to the price of the items. As such, users interested in spending a certain amount of money can search by price. The user selects a particular price range, and is presented with a listing of all items that can be purchased and donated within the selected price range.

Another option the user has is to search for charitable organizations by location. The participating charitable organizations are organized in a database according to their location. A user can search for participating charitable organizations with a particular geographical area. For example, a user can enter his location, such as by zip code, and a desired geographical range, such as a radius of ten or twenty miles of the entered zip code, and the user is provided with a list of charitable organizations located within the selected geographical range. In addition, GOGGLE can be used to determine the current location of the user, and participating charitable organizations located within a particular geographical range of the user's location can be presented on the user's screen. This can help people gain trust as well as be enable people to personally visit participating charitable organizations.

Another option is for users to search by “urgency of need.” A database is maintained of items listed by charitable organizations, in which the expiry date set by the organization is within the next three days. Such items could include perishable food, and other items of an urgent nature, such as relief items for victims of recent natural disasters. This items registry would display to users and marked for review, while all the followers for organization would get an email to review and help on completing the order required.

The listings of charitable organization items that are provided in response to searches by users would include information such as the name of the item, name of the charitable organization listing the item with a link to their profile page, the quantity needed/desired by the organization, and the price/cost of per item. Items can be listed for purchase with specific quantities or have option for users to alter the quantity as desired. Upon clicking on a particular item, the user is taken to a detail page of the item for the product listed by the organization.

Upon selecting items 18, the user has the option of purchasing the item as a guest account (anonymous), a registered user, or social sign-in. As a guest account, a purchase can be made by selecting the item and going through the payment process. No additional information from the user is required, and no information regarding the user is saved on the website for later use. This allows for anonymous purchases, and can be the quickest way possible to get through the process of purchasing items listed.

Another option is to purchase items as a registered user. A registered user can login with previously signed up credentials or the user can create a new account using his unique email address. Another option is social sign-in. A user can sign-in using Facebook® or other social media account, and can showcase his donations to others invite others to participate via social media accounts.

When signing up as a registered user, the user must input certain mandatory information mandatory, such as name, telephone number, e-mail address, and mailing address. This information is passed to the payment gateway to process payment.

Users can add items to their check-out cart 20 by selecting desired items. Once they have completed collecting items in the cart, they are given the option to login or sign-in as a guest. Each purchase can be recorded in an administrative console.

There are three major stages of the buying process 22: (1) cart items are listed for confirmation by the user to continue; (2) the user enters credit/debit card information; and (3) the user is presented a “Thank You” page for confirmation. Upon collecting all desired items, the user can purchase the selected items, and complete the process by entering credit card information. This information can be passed to a payment gateway selected to support the website. On completing the payment process the user can be redirected to the website.

Upon completing a purchase, users can share an update about his charitable donation on Facebook® for their friends to like and share the platform to do good for causes they want to support. This can give the website a social presence and also make it viral.

Users who create an account for making purchases or get updates from the website can have the following options available on a “My Account” page: Donation Summary, Web Portal Analysis, Shipment Details, Follow Charitable Organization profile (on website to help them in future), and Tax saving certificate

“Donation Summary” provides all details of products purchased and donated, with the date, items and amount spent purchasing the items.

“Shipment Details” tracks the items from the vendor portal and provides tracking information for the user to see the items getting delivered on their behalf.

“Follow Charitable Organization” allows the user to search for participating charitable organizations by their cause, distance from the user, or by city and state. Looking at the different organizations, the user can see profile pages for the organizations they want to follow to get regular updates regarding new uploaded items.

“Tax Saving Certificate” generates tax certificates from an online portal which can be downloaded from the website user login page. This can be made a part of the invoice with specific information which would be sent by the Administrator of the site.

A variety of e-mail communications are sent to users of the system. These e-mails include a “New Registration” e-mail, which is sent out to verify the e-mail address of a person registering on the site. A “Lost Password” e-mail can be sent when a user requests to reset his password when forgotten.

A “Following Updates” e-mail can be sent to users providing monthly/weekly updates regarding new items for all the charitable organizations that user is following.

An “Items Delivered” e-mail can be sent to a user when an item is delivered to the particular charitable organization to which the user has donated the item. As such, the user can be assured he has made a valuable contribution.

Participating Charitable Organizations, including Charities with 501(c)3 registration on the website, can interact with the system, and only relevant information is requested from the charitable organizations to maximize the ease of them signing up in the system. Also, intuitive options for creating the profile page of the charitable organization are provided. Below are processes which would be implemented to achieve the same.

During the sign-up process of a new charitable organization on the website, a 501(c)3 member registration page is displayed for the organization. On this page, the following information is requested for the initial sign-up process: name of the charitable organization, physical address, e-mail Address, telephone number, employer identification number (also known as the IRS Federal Tax Identification Number or Tax ID number). In addition, the charitable organization is asked to confirm that their shipping address is the same as the physical address entered and if not are given the option to enter a different shipping address. An e-mail for confirmation of the entered—mail address is sent to confirm the e-mail address and is required for validation and unique registration. The e-mail confirmation link would be valid for seven days. After seven days, upon attempting to log in, the organization is asked to resend the e-mail and confirm the same before log in. This process is required to confirm that all important notifications to the organizations are received by them.

On the next page of registration, the charitable organization is required to choose a membership account type and payment options. The organization is given the option to pay for membership monthly, quarterly or annually. On selecting a payment option, the organizational user is redirected to the payment gateway for completing the transaction with recurring charge(s) as per the payment plan selected. Upon successful registration, the organizational user is redirected to a thank you page and a confirmation e-mail is sent to the registered organization.

Upon signing up, the charitable organization is verified by the administrator upon getting confirmation of the charitable organization having a completed 501(c)(3) registration, such as by online website www.501c3lookup.com.

Once a charitable organization is validated they would be sent an e-mail requesting the charitable organization to complete a profile page. A profile page is provided to all registered charitable organizations on which the organization can enter information about the organization's mission/goal. The organization can post images, videos and other information to promote their cause and encourage participation.

The profile page attracts donors to the cause and helps users find something which resonates to their day to day life. Users who are interested in a particular profile page can “like” the profile page by clicking a “Like” button on the profile page. Upon doing so, the user receives regular e-mails from the organization that provide updates regarding new items available for purchase for the particular organization. This helps gets people to connect more often to the website to help and make more purchases.

A “My Account” page has links to all account related information for adding members to the organization, while also checking on items listed for registry and purchased and donation amount. Using this page, participating organizations would have following features:
Change Password
Send Feedback to site administrator
Check on items which have been donated earlier with date range
Registered Items
Followers
Expired item notification
Change profile page and settings
Disable\Enable Account
Referral Link\banner to get other organization(s) to sign-up

Once an organization completes initial registration it is given access to complete vendor listings for making selection and preparing their registry for users to donate items. Each registered item is linked to the organization's profile and shown on the profile page so users have easy access to the items. These items can be selectable from different categories provided by vendor and can be added in different quantities. Upon selecting the items, organizations would be able to list the quantity of items, which can be purchased and donated. Users can select to purchase the entire quantity or any number less than the total quantity. Upon purchase of an item, a notification can be sent to all followers of the particular organization, notifying them of the purchase of the item, and quantity of the particular item left to be purchased by donors.

Each item can have an expiry date. If the organization does not enter a specific expiry date for an item, then by default the expiry date is set to three months. The expiry date can be changed as desired by the organization. When the expiry date is reached for an item, the organization receives an e-mail notifying it of same and the organization has the option of changing the expiry date.

Upon uploading items on the website, participating organizations can connect their profile to social media websites, such as Facebook®, to promote purchase of its items on social media.

When an item is purchased by a user, an e-mail is sent to the charitable organization associated with the purchased item. The e-mail includes information such as the quantity of items purchased, purchase number, date and other details for tracking the item.

Shipments and purchases can be tracked from organization internal pages with e-mails being sent for purchase, items being shipped and tracking for the items provided by the vendor system.

A number of reports can be generated for the administrator of the website using information collected from the registrations of users, organizations and other related information. The following reports can be generated:

User\Donors Registration: this report allows the administrator to see all registrations for people interacting with the system and the profiles of those who have donated the most.

Organization registration under 501(c)3: this report lists all the participating organizations and allows the administrator to browse all the organizations by their registration date and activities

Items purchased and Invoicing: this report provides data regarding all purchased items by users on the site with organizations that are getting the most views and items donated.

Shipping details: This report provides quick access to all shipped items, delivered items and other details to make it easy for interacting with different organizations.

Administrators have the option to activate or deactivate all accounts created in the system in order to control the best use of the site and safeguard best interest of the site.

Administrators to the system can execute multiple tasks on behalf of users to assist them in better utilizing the systems. These functions include tasks such as:
Switch as organization profile for any organization: using this option administrators can switch and login as a specific site user or organization to make changes on their behalf to help ease out daily feedback checks and work with any user to get things corrected with ease.
Switch as user profile for any donor: using this option administrators can log in as a user to make changes on their behalf.
Manage NGO and User accounts

A Banner/News Administration section of the website provides administrators access to banners on all pages of the site. The banners can be for advertising purposes and/or getting users attention for taking a specific action. Administrator can perform the following tasks:
Add new Banners: new banners can be uploaded according to website real state assigned and pages the banners might show.
Manage Banner: using this option, administrators can manage banners for rotation as well as display properties as required and on need basis. However, default values can be put in place.
Content Editor for main pages: all website pages are dynamic and administrators can make changes to content using this section required.
Add News: news can be added on specific news sections of the website.
Manage News: this option provides access to administrators to alter the news, disabling an article and/or change formatting.

Feedback query sections can be provided on the My Account page of users and participating organizations through which users and participating organizations can provide feedback to the site administrators.

A vendor catalogue can be maintained having information relating to vendors that can supply items that participating organizations are potentially interested in listing on the site. The catalog can include specific information and table of contents that can be manually updated in the system. The catalogue can contain product information and pricing information from which interested charitable organizations can select items for listing on the site.

When a user place an order, an automated email is sent to the vendor of the item purchased. The e-mail provides a unique identification number in the system and mapped fields from the vendor catalog along with a purchase order. This information is sent to the vendor, which further processes the order for delivery of the item. Additional e-mails are sent to the user making the purchase, the organization for which the item is purchased, and the administrator to confirm a new order is in process. The vendor can pull all required reports by criteria, such as items purchased, shipping details, payments cleared, and task report.

The participating charitable organizations can be charged a membership fee for being registered on the site. The membership fee can be assessed at a flat rate or based on usage in a pay per click or transaction. Additional revenue can be generated by charging a percentage markup on the price of each item purchased on the website. The funds generated from the purchase of items on the site can be held in an interest bearing sweep account for thirty days prior to paying invoices from suppliers.

In order to encourage charitable organizations to register on the site, there can an initial trial period in which organizations can participate at no charge in return for feedback. After the initial trial period, the organization can be charged regular membership fees.

The system facilitates trust between charities and their donors, while providing the convenience of online shopping. In addition to streamlining the processes of donation collection, the risk of fraud and misuse of funds are minimized. The convenience factor provided to the charitable organizations and the public can have a positive impact on donations. The system gives donors to charities the ability to choose exactly what they want to donate and the amount of money spent.

A method of facilitating charitable donations is described above. Various changes can be made to the invention without departing from its scope. The above description of the preferred embodiments and best mode of the invention are provided for the purpose of illustration only and not limitation—the invention being defined by the claims and equivalents thereof.

What is claimed is:

1. A method of facilitating charitable donations comprising the steps of:
(a) providing an organizations database comprising a listing of charitable organizations;
(b) providing an items database comprising a listing of tangible items available for purchase by potential donors for the charitable organizations, wherein at least one of the tangible items is designated for donating to at least one of the charitable organizations, whereby the potential donors search the items database and select at least one of the tangible items therefrom to purchase for at least one of the charitable organizations; and
(c) purchasing the at least one of the tangible items selected from the items database.

2. The method according to claim 1, further comprising the step of delivering the at least one purchased tangible item to the at least one of the charitable organizations designated to receive the at least one purchased tangible item.

3. The method according to claim 1, wherein the tangible items comprise at least one item selected from the group consisting of food, water, clothing, building supplies, medical supplies, and educational materials.

4. The method according to claim 1, further comprising the step of providing a forum wherein potential donors can search the organizations database and the items database.

5. The method according to claim 4, wherein the forum comprises an Internet website.

6. The method according to claim 5, further comprising the step of providing an administrator maintaining the website, and overseeing activity on the website.

7. The method according to claim 5, further comprising classifying the items listed in the items database according to the cost of each of the items, whereby potential donors can search for items based on cost.

8. The method according to claim 5, further comprising classifying the charitable organizations listed in the organizations databases into a plurality of sub-databases to facilitate searching of the charitable organizations.

9. The method according to claim 8, wherein charitable organizations in the organizations database having a particular common mission are classified in a common sub-database whereby potential donors can search for organizations having the particular mission.

10. The method according to claim 8, wherein charitable organizations in the organizations database are classified according to their geographical location whereby potential donors can search for organizations in a particular geographical area.

11. A system for facilitating charitable donations comprising:
(a) at least one database comprising a listing of charitable organizations and tangible items available for purchase for the charitable organizations, wherein each charitable organization is designated as a recipient of at least one of the tangible items; and
(b) an Internet website functionally connected to the at least one database whereby a user of the website can search the database and select at least one of the tangible items therefrom to purchase for the charitable organization designated as recipient of the tangible item.

12. The system according to claim 11, further comprising a purchasing portal for executing the purchase of items on the website.

13. The system according to claim 11, wherein the tangible items comprise at least one item selected from the group consisting of food, water, clothing, building supplies, medical supplies, and educational materials.

14. The system according to claim 11, wherein the tangible items are classified in a plurality of sub-categories functionally connected to the website to facilitate searching of the tangible items by the user of the website.

15. The system according to claim 14, wherein each of the tangible items is assigned an expiry date, and each of the tangible items having an expiry date within a specified time period are classified by expiry date, whereby the user of the website can search for items by expiry date.

16. The system according to claim 11, wherein the tangible items are classified according to the cost of each of the items, whereby the user of the website can search for items based on cost.

17. The system according to claim 11, wherein the charitable organizations are classified into a plurality of sub-categories functionally connected to the website to facilitate searching of the charitable organizations by the user of the website.

18. The method according to claim 16, wherein charitable organizations having a particular common mission are classified in a common sub-category whereby the user can search for organizations having the particular mission.

19. The system according to claim 16, wherein the charitable organizations are classified according to their geographical location whereby the user can search for organizations in a particular geographical area.

20. The system according to claim 11, further comprising a profile page for each of the charitable organizations, the profile page providing information about the charitable organization.
